(19) United States
(12) Patent Application Publication
(10) Pub. No.: US 2005/0217773 A1
(43) Pub. Date: Oct. 6, 2005

(54) Motorcycle rack protective cover

(76) Inventor: Karen E. Brubaker, Carmichael, CA (US)

Correspondence Address: Ken Campbell, PO Box 551, Fair Oaks, CA, 95628, US

(21) Appl. No.: 10/820,392

(22) Filed: Apr. 6, 2004

(51) Int. Cl. B62J 11/00

(52) U.S. Cl. 150/167

(57) ABSTRACT

This invention is a protective cover that effectively and neatly encloses the contact surfaces of a motorcycle luggage rack. By its unique design, this protective cover can be fastened securely, while it conceals its hardware from view. The design of this cover performs two distinct functions. One is in preventing wear of chrome plating on the rack itself. The other function is in maintaining an appropriate level of aesthetics when used as an accessory. Both functions are highly valued and appreciated, by the average motorcycle enthusiast.

### SUMMARY

This invention relates to motorcycles. Classic-style motorcycles have been popular with riders since the days of early production. Enthusiasts focus on stringent maintenance and crisp detailing. The hardware of many classic-style motorcycles are trimmed with chrome plating. Motorcycling enthusiasts often go to great lengths to preserve the original appearance of this hardware. However, with motorcycle luggage racks specifically, chrome-plating can easily be chipped from careless handling of baggage.

Preventing this chipping in a convenient way, while preserving the style of the frame detailing, is not an altogether simple task. Yet, it is a realistic concern for anyone who wishes to avoid costly repairs and replacement hardware. In accordance with the invention, the device is a fitted cover. This device provides a smooth bearing surface, as well as an effective, reliable means for being fastened to a motorcycle luggage rack.

### REFERENCE TO DRAWINGS

Drawing Figures

FIG. 1 shows the side view of a typical motorcycle luggage rack.

FIG. 2 shows the device as it is handled prior to application.

FIG. 3 shows the device as it is being applied to the rack.

FIG. 4 shows the device mounted onto the rack, as it is being secured.

FIG. 5 shows the simple appearance of the device, once it is mounted and secured to the rack.

FIG. 6 shows the device, as it is used to protect the rack from incidental damage.

FIG. 7 shows a perspective view of the device alone.

### REFERENCE NUMERALS IN DRAWINGS

10 Cover

20 Sleeve

30 Flap

40 Snap

### DETAILED DESCRIPTION

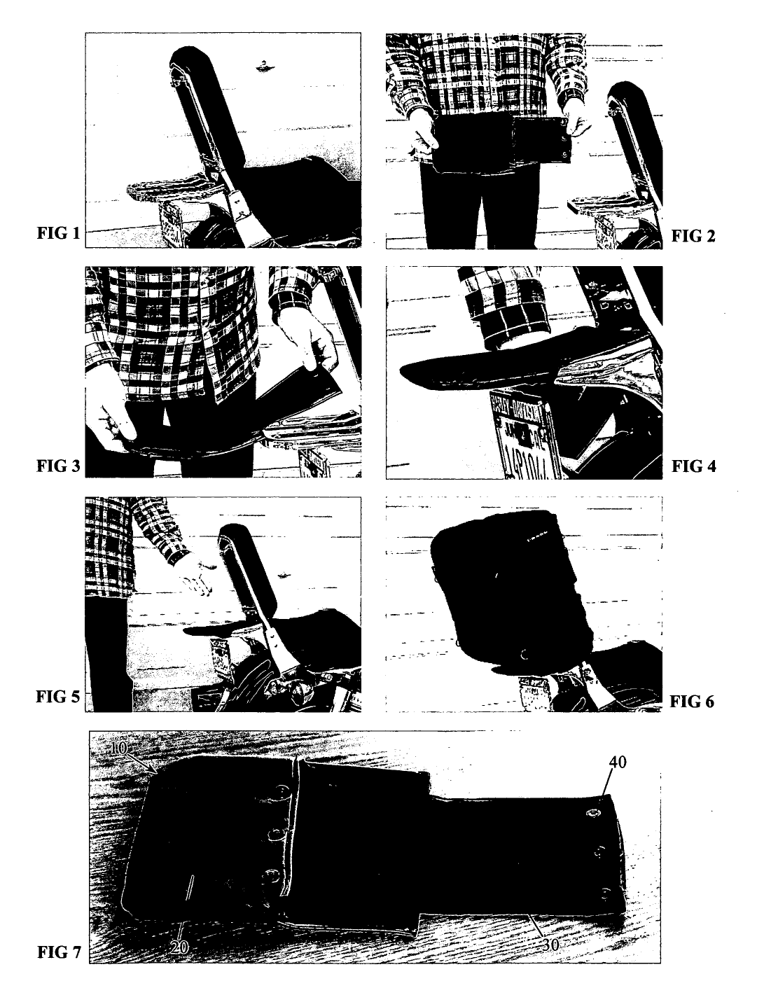

The preferred embodiment of the invention is shown in FIGS. 1-7. This embodiment comprises a cover 10, which includes a sleeve 20 portion, a flap 30 portion, and a means for fastening said flap to said sleeve. In this case, said fastening means is a plurality of snaps 40. Said sleeve portion fits snugly onto the luggage rack. Said sleeve is held in place by the flap, which is effected by its fastening means. Once the cover is applied to luggage rack, it effectively protects the underlying chrome from chipping and damage.

In this embodiment, the cover is sewn from a single piece of appropriate material. Said cover may also be made from several pieces of material, and may be fabricated in many suitable ways. The means for fastening is constructed onto the flap and the sleeve, in such a way that the cover can be mounted to the luggage rack snugly and securely.

1. A protective cover that fits snugly onto a motorcycle luggage rack, and is secured to said rack by way of an appropriate fastening means, which is so positioned so as to function reliably and conveniently.
